(19) United States
(12) Patent Application Publication
(10) Pub. No.: US 2008/0271122 A1
(43) Pub. Date: Oct. 30, 2008

(54) GRANULATED HARDWARE RESOURCE PROTECTION IN AN ELECTRONIC SYSTEM

(76) Inventors: John Edward Nolan, Sacramento, CA (US); Rajeev Grover, Rocklin, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/741,673

(22) Filed: Apr. 27, 2007

(51) Int. Cl. H04L 9/32

(52) U.S. Cl. 726/4; 726/5

(57) ABSTRACT

A control logic secures access to an electronic system. The control logic comprises an initialization logic and an operational logic. The initialization logic allocates access rights individually among a plurality of hardware and/or operation elements in the electronic system and individually secures the plurality of hardware and/or operation elements with electronic and/or software-activated access. The operational logic responds to attempted access by a user to authenticate hardware and/or operation elements and enable operation of the hardware and/or operation elements upon authentication.

### BACKGROUND

Physical access protection is an important link in overall security strategy. Much recent attention has been given to network security with physical access security lagging behind. Physical access should not be a weak link in a security chain. Current methods of physical access protection combine aspects of logical authentication for data center access, racks protected by lock and key, and server chassis and front panel protected by lock and key. Some problems are inherent with the current security approach. First, access is on an all-or-nothing basis. Either the key is available or not so that granular access is unavailable. Second, access is difficult to manage with no available auditing of who accesses the system and at what time. Keys can be copied or lost, and then the lock is to be replaced. Access management difficulty increases with the number of systems deployed, and the number of employees with access.

Typical methods for securing hardware in a data center involve physically locking each server to prevent access to chassis or controls without key. Physical locks are cumbersome when many servers are deployed or when many people access are allowed access to the devices.

Current techniques are lacking in fine-grained physical access to servers. In bladed or partitioned systems, no technique is available to deny access to resources that are not owned by a user. No technique is available to grant access to only those resources that are owned by a user in the bladed or partitioned system. Access rights to different users are not distinguished.

Authentication can be required to enter data center or portion of data center, but does enable access with server granularity and gives insufficient information for an audit trail.

A security technique by usage of a lock and key for a server or rack is difficult to manage as number of servers grows. Audits are performed manually as keys are checked out.

### SUMMARY

An embodiment of control logic secures access to an electronic system. The control logic comprises an initialization logic and an operational logic. The initialization logic allocates access rights individually among a plurality of hardware and/or operation elements in the electronic system and individually secures the plurality of hardware and/or operation elements with electronic and/or software-activated access. The operational logic responds to attempted access by a user to authenticate hardware and/or operation elements and enable operation of the hardware and/or operation elements upon authentication.

### BRIEF DESCRIPTION OF THE DRAWINGS

Embodiments of the invention relating to both structure and method of operation may best be understood by referring to the following description and accompanying drawings:

FIG. 1A is a schematic block and circuit diagram depicting an embodiment of an electronic system adapted with granulated physical resource protection;

FIGS. 1B, 1C, and 1D are schematic block diagrams showing protected resources in various configurations;

FIG. 1E is a schematic block diagram showing an embodiment of an electronic system that manages group access rights; and

FIGS. 2A through 2D, multiple flow charts illustrate one or more embodiments or aspects of a method for securing access to an electronic system.

### DETAILED DESCRIPTION

Industry trends of server consolidation, and increased security requirements create additional incentive to seek improvements to current physical access security solutions. As servers consolidate, different entities are more likely to share server resources. Creating granular access rights at the blade, or server level promotes consolidation ensuring that each entity only has physical access to the resources owned by the entity. In addition, refining access rights to resource level and incorporating logical authentication greatly increases overall system security.

A security system and associated security techniques increase security in an electronic system such as a server by implementing electronic authentication, for example smart card, personal RFID identification, biometrics, voice or face recognition, a virtual authentication device, or the like, to gain operation or physical access to the electronic system, or part of the electronic system. Security enables the electronic system to protect resources available via physical access, for example chassis, blade, partition, disks, reset, console, keyboard, mouse, and others, at the resource level. The illustrative techniques also enable users to have individual security access rights with finer granularity. Electronic authentication for physical access enables collection of an audit trail on physical access.

The illustrative security system and security techniques enable central administration of physical access rights, simplifying operations for large installations. Central physical access right management can be incorporated and managed with logical access rights.

The illustrative security system and techniques enable fine-grained physical access to servers, with user-access personalized to blades or partitions owned by the user. A user is enabled to change operate, access, or remove a disk or blade with ownership or access rights to different users distinguished. For example, access can be controlled by enabling specific individuals to be authorized for different levels of access. In a server, the described security system increases the level of protection for the server, disk arrays, the rack, and any other valuable physical resource.

A server implementation of the illustrative security features scales from a single server to large servers with several partitions with utility in a single server model, but most useful when used for blades or partitioned systems. Similar scaling can be implemented for other devices such as switches, disk arrays, racks, and many other hardware or system types.

The disclosed system also enables tracking of users who physically access the server, and the time and date of access. The electronic system can be used in combination with other security tools that determine actions taken by the user during the access and correlation of access data, features that enable more complete and accurate reports for Sarbanes-Oxley reporting since users are authenticated before physical access is allowed.

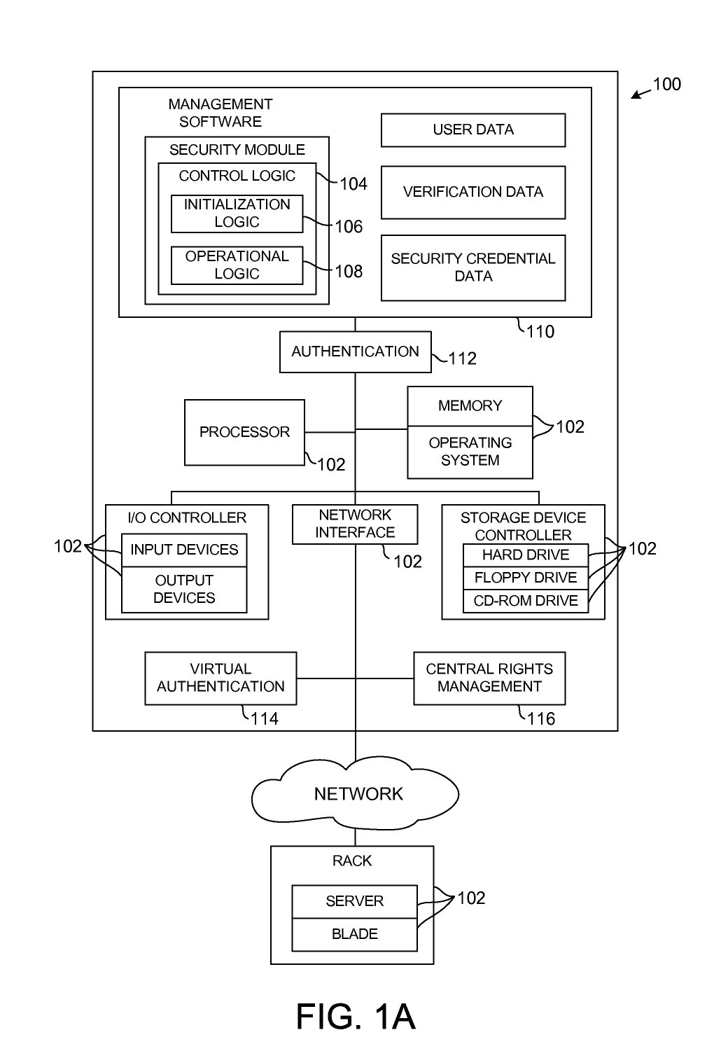

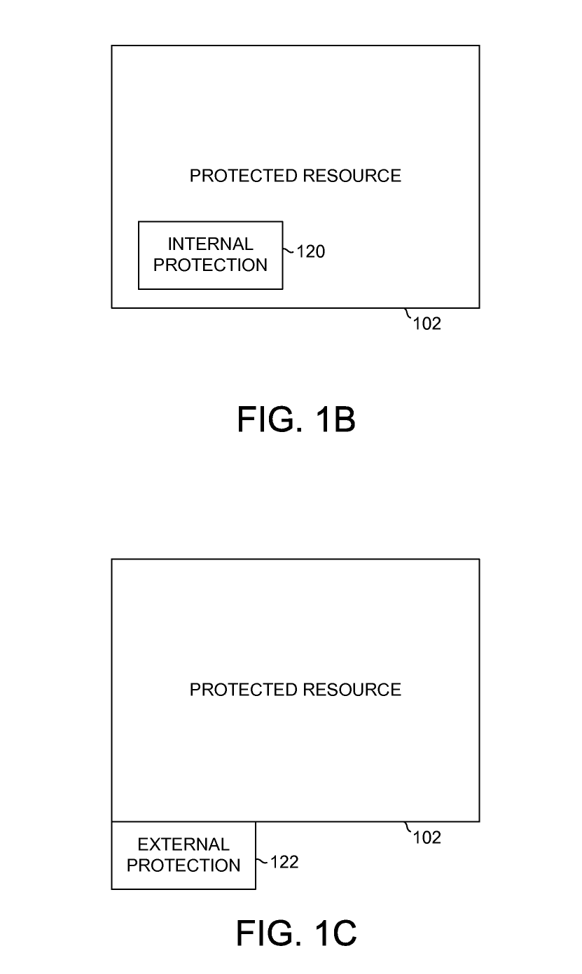

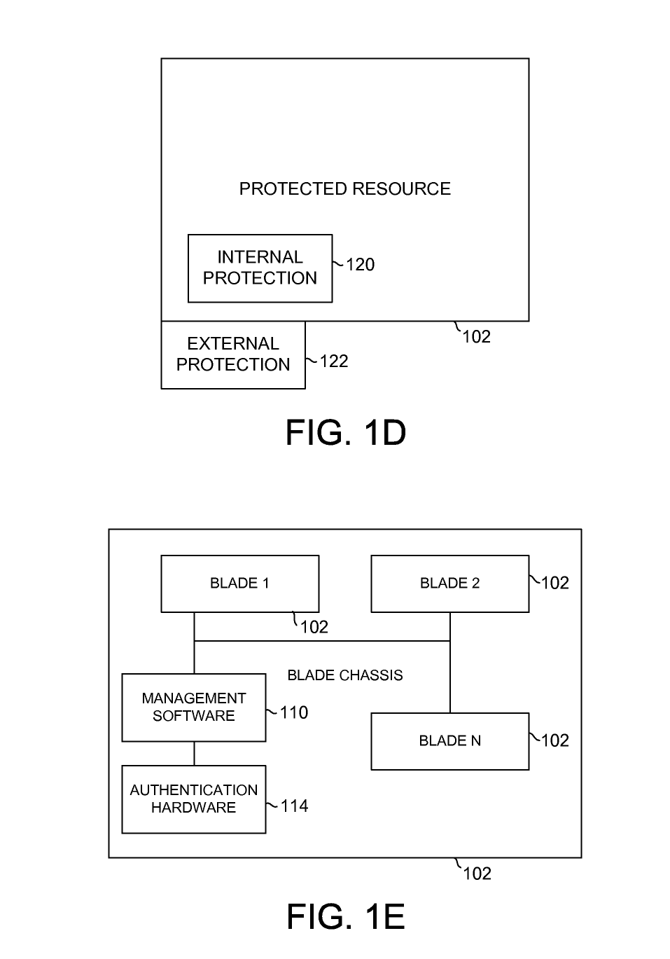

Referring to FIG. 1A, a schematic block and circuit diagram depicts an embodiment of an electronic system 100 adapted with granulated physical resource protection. The illustrative electronic system 100 comprises multiple physically and/or communicatively coupled hardware and/or operation elements 102 and a control logic 104 which is operational as part of management software 110 for securing access to the electronic system 100.

The control logic 104 comprises an initialization logic 106 that is operative to allocate access rights individually among the multiple hardware and/or operation elements 102 and individually secure the hardware and/or operation elements 102 with electronic and/or software-activated access. The control logic 104 further comprises an operational logic 108 that is operative in response to attempted access by a user to authenticate selected items of the hardware and/or operation elements 102 and to enable operation upon authentication.

The electronic system 100 further comprises an authentication block 112 which can be used to authenticate a hardware and/or operation elements 102 to enable operation or access. For example, the authentication block 112 can be authentication hardware that, for example, can prevent hardware removal unless authorized.

In some embodiments, the electronic system 100 can also include a virtual authentication block 114 and a central rights management block 116 which are coupled to a network. The virtual authentication block 114 enforces secure virtual electronic authentication. The central rights management block 116 can be used to enforce digital media access rights.

The illustrative techniques can be applied to a wide variety of electronic systems, for example to servers, partitioned servers, bladed servers, server racks, computer systems, consumer electronic systems, network systems, network switches, storage arrays, disk arrays, smart-device disk arrays, network interface controllers, storage controllers, disk controllers, and the like. Similarly, the techniques can further be applied to cellular telephones or other communication systems, entertainment system, and the like. The techniques are generally applicable to any suitable electronic property.

For example, is illustrative system and techniques can be used for property protection in general. Device operation can be a protected physical access that is controlled by authentication, such as RFID authentication, wherein an RFID transmitter is located in the vicinity of the protected device but not internal to the device. RFID authentication is thus limited to the range of the RFID transmitter. Accordingly, operation of the protected device can be limited to a home.

In various applications, configurations, and embodiments, a protected resource 102 can be protected using a combination of internal protection mechanisms 120 and external protection mechanisms. Referring to FIGS. 1B and 1C, the protected resource 102 can have an internal protection mechanism 120 or an external protection mechanism 122, respectively.

Similarly, the illustrative techniques can be applied to allocate access rights and secure a wide range of hardware and/or operation elements. For example, the initialization logic 106 can be operative to allocate access rights and secure one or more hardware and/or operation elements such as servers, partitioned servers, virtualized systems, optical devices, and bladed servers. The initialization logic 106 can secure wide area network (WAN) port connections and local area network (LAN) port connections to prevent unauthorized access to data or systems on a network. The initialization logic 106 can be implemented to secure processors, central processing units (CPUs), storage devices, disk arrays, switches, embedded system devices, communication interfaces, user interfaces, blades, partitions, chasses, disks, reset buttons, consoles, keyboards, mice, trackballs, joysticks, memory, input/output (I/O) cards, power supplies, fans, field replaceable units (FRUs), light-emitting diodes (LED) displays, liquid-crystal displays (LCDs), diagnostic panels, and displays.

In general application, the illustrative electronic system 100 and associated control logic 104 can be implemented to secure electronic devices in general, home electronic devices, home and office, automobiles, and the like, for example to prevent theft.

In a partitioned system, a large server is divided into partitions, each of which can run a separate application. The partitions can be electrically isolated as hard partitions or partitioned by management software in soft partitions. In either case, access rights can be configured to match partition resource allocation and ownership. The individual partitions may be owned by different entities. The illustrative electronic system 100 and control logic 104 enable the individual partitions to be secured against access by an unauthorized entity. Physical access rights can be structured to reflect ownership so that access rights are similarly partitioned in the manner of partitioning of the hardware.

In various applications, access rights can be granulated to multiple levels. For example, some authorization can extend to whole machines while other can enable access to individual disks, a group of blades, an individual blade, an individual resource on the blade such as a disk or reset button, or the like.

The operational logic 108 can be used with a variety of security devices, systems, and technology. For example, the operational logic 108 can be implemented to control a single security device or technology, but more likely is implemented with a capability to manage multiple types of security systems and technologies. Security technologies supported by the control logic 104 can include retina scan biometrics, fingerprint biometrics, voice recognition, image recognition, smart cards, magnetic swipe cards with associated pin, personal radio frequency identification (RFID). Some implementations may use secure virtual electronic authentication. A keyboard and/or keypad entry can be used with a user name and login password. In some embodiments, a servo-electronic-activated physical barrier can be used to protect a resource.

Biometrics or smartcards can be used for operating system access. The illustrative electronic system 100 enables biometric and smartcard security for physical hardware access. Secure virtual electronic authentication can also be used to control access and operation of an operating system.

An encryption key can be implemented that enables data usage. Firmware can enable activation of a feature and/or an associated resource. Similarly, the control logic 104 can enable a run mode or execution of an operating system and/or an application which is executable by the operating system. The control logic 104 can implement security by enabling an execution mode by authorization as part of an authorization chain that sets permissions for multiple security layers. Execution mode can be selectively promoted or demoted by additional authorization.

The control logic 104 can implement security via a combination of security technologies. For example referring to FIG. 1D, a protected resource 102 can be protected using two-part protection including an internal protection mechanism 120 and an external protection mechanism 122. Initialization logic can reside on the protected resource, as shown by the internal protection mechanism 120. The internal protection mechanism 120 can be logic that validates an operating environment or to ensure proper authentication has been registered before a device 102 operates. The external protection mechanism 122 can be, for example, a lock that prevents the resource 102 from being removed.

In some applications, a two-part key can be associated with a respective resource and chassis pair to enable operation only in combination. Two-part lock protection can be used to prevent a resource from removal from an authorized machine and installation in an unauthorized machine. Both portions of a lock are needed to enable operation of the resource. Two-part keys also can enable sharing of hardware resources between chassis in the same group while preventing running from other chassis.

The control logic 104 can be configured to allocate access rights according to a wide variety of considerations, according to the particular electronic system 100 and associated resource elements 102 that are protected and according to various considerations and conditions relating to the characteristics of the desired security. For example, the access rights can be granular access rights wherein individual resources have an associated access right. In some arrangements, the access rights can be locally managed, centrally managed for example using a utility such as Lightweight Directory Access Protocol (LDAP) or other protocols, or can be globally managed.

The access rights can be managed to change dynamically with partitioning and/or virtualization with ownership changes tracked. For example, an error condition in a memory module can be detected and access rights can be triggered by the detection event which limits access to the failed module.

Group access rights can be managed according to user, resource, machine, and/or location. Referring to FIG. 1E, a schematic block diagram illustrates an embodiment of an electronic system 100 that manages group access rights. A blade chassis and multiple blades are managed as resources 102 under security control of management software 110 and authentication hardware 112. A blade or partition can be managed as resources 102 with the chassis containing multiple blades or partitions. The multiple blades and the chassis can share authentication hardware 112 that communicates with the management software 110 to implement secured access.

In a particular application, chassis and servers can be assigned to groups owned by an entity and accessible interchangeably within that group. For example, a blade can be removed from a server but the access rights can be implemented so that the blade is not functional in another server that does not have authorization. In another example, an RFID key in a data center can tie a resource to a location. In a further example, access rights can be assigned at manufacture specifying access for only certain authorized technicians. In some applications, access rights can be used to define resource capabilities.

Access rights can be determined based on the operating system.

In some implementations, access rights can be determined by hardware. For example, the occurrence of an event can trigger access rights which enable access to malfunctioning hardware. By tying access rights to both the hardware and the event, malfunctioning or broken hardware can be accessed for repair.

Access rights can be allocated according to resource capability and/or functionality. For example, access rights can be dependent on model number. In some applications, access rights can be made interoperable with operating system and executable application for enable and disable. Access rights can be allocated to that authentication is required to enable firmware and/or software features. Access rights can be allocated as physical access permissions for bootstrap loading while an operating system is executing. For example, physical access rights can be tied to licensing which enables and disables features according to license rights.

The control logic 104 can be operated so that access rights are determined by location of the resource elements 102. Access rights can be allocated to hardware in groups or can be allocated to multiple users. Access rights can be paired according to user and resource, or according to user and location. Similarly, access rights can be allocated based on a combination of user, resource, and location.

Access rights can be encoded and/or encrypted to prevent tampering. Access rights can be allocated according to date and time. Access rights can be configured to protect against resource removal, preventing a resource from removal from a system. Similarly, access rights can be configured to require authentication for bootstrap loading of an operating system. In some applications, access rights can be allocated to require the correct running mode for executing software, an example of a general technique of implementing access rights to protect resource usage. Access rights can be implemented to limit operation to a designated location. For example, access rights can be used to limit operation to a designated shipping address and RFID data center location key.

Access rights can be tracked during resource operation. Access rights can be queried by an operating system or executable application during a working session, and can be promoted and/or demoted during the working session. For example, at bootstrap loading a relatively high authorization can be set for operation at a root level and authorization demoted to an operator level subsequently.

In applications for facility security, such as data center security for a network of clients and servers, access rights can protect LAN port connections in a server or switch.

Access rights can be determined by events and/or conditions. For example, access rights can be enabled to activate a resource that is disabled by default. In another application, access rights can be activated by shipping of resource to an address.

In an example embodiment, electronic system hardware can have electronic authentication using an available technology such as retina or finger print biometrics, smart card, or personal RFID identification. In other examples, electronic system management software can perform secure virtual electronic authentication. Server hardware resources including blades, partitions, chassis, disks, reset button, console, keyboard, mouse, and the like, can each have an associated access right. Each protected resource can have either an electronically activated physical lock in the case of chassis, blades, disks, and memory, or an electronic way of disabling operation such as a multiplexer for the reset button, keyboard, console, and mouse.

In some examples, the protection mechanism can be controlled by management software that reads a hardware authentication method and validates the user against an internal or external (LDAP) access list. Once validated, the users' access rights are checked. Management software then enables corresponding features that are authenticated for the user.

User login and possibly access rights can be recorded in a management audit log. A second authentication or a timeout can log the user out when done.

Implementing fine-grained physical access control with audit capabilities enables significant security control and reporting which is particularly useful in blades or partitioned servers wherein different entities may own different parts of the server. For example, the illustrative access control can eliminate usage of unauthorized software by preventing addition of a new disk or usage of a compact disk (CD) or digital versatile disk (DVD). A single user mode attack can be prevented by protecting access to a video graphics array (VGA) console and keyboard

The described electronic system 100 and control logic 104 enable protection of all physical resources of the server individually and prevent removal of valuable hardware such as a blade, a disk, memory, a CPU. The system 100 also prevents addition of new unauthorized software by adding a new disk or DVD. The electronic system 100 prevents local attacks by disabling the keyboard and console, and the reset button.

The electronic system 100 enables users to have individual access levels.

Protection for the electronic system 100 can be implemented according to two general considerations. A first step is enumerating all resources to be protected and identifying a protection method for each resource. Next, a logical authentication technique is implemented to grant physical access, for example using a management hardware device that runs when system power is off. Typically, many servers include some type of management processor. This management processor can be extended to control the protection mechanisms, and authenticate uses to grant access to physical resources.

Partitioning system resources to a device level enable more stringent and flexible physical access policies. Any valuable resource or access permission can be identified. Resources can be anything with value, including blades, disks, central processing units (CPUs), dual inline memory modules (DIMMs), and the like. Access permissions relate to authorization to access at least part of the system. Relevant permissions include access to opening a chassis, input to a keyboard, and viewing console output, for example. After identifying desired protected resources, including considerations of cost of protection and likelihood and consequences of resource exploitation, a protection mechanism for each resource is identified. Most resources can be protected with a servo-activated locking mechanism, but others may be protected by a disabling feature in the manageability subsystem. The manageability subsystem controls the resource protection.

Logical authentication by smart card, biometrics, RFID, or password involves additional hardware to receive user information for authentication. Several methods can be combined to enable multi-factor authentication. The manageability subsystem authenticates the user and determines access rights. Logical authentication can support many users, each which may have different access rights. Management of users and physical access rights can be centralized using a directory service.

The combined security for multiple resources enables security policies for physical access to the resource level. Multiple people can have different access rights to the same machine which is particularly useful in the case of blades or partitioned systems where resource ownership may be divided between many parties. Each party can be granted access only to the resources they own. Moreover, the security technique can adapt quickly without user interaction to handle dynamic partitioning, and can be extended to virtualized systems for cases that a virtual machine can communicate resource ownership information to management hardware.

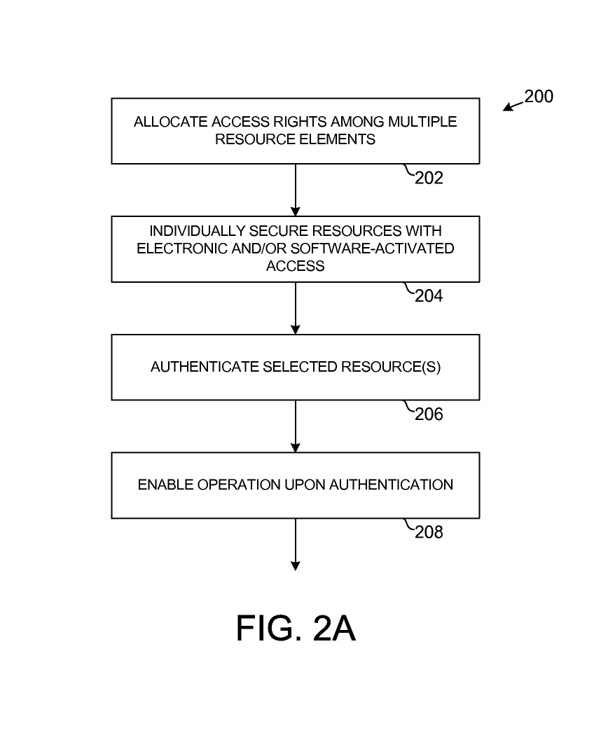

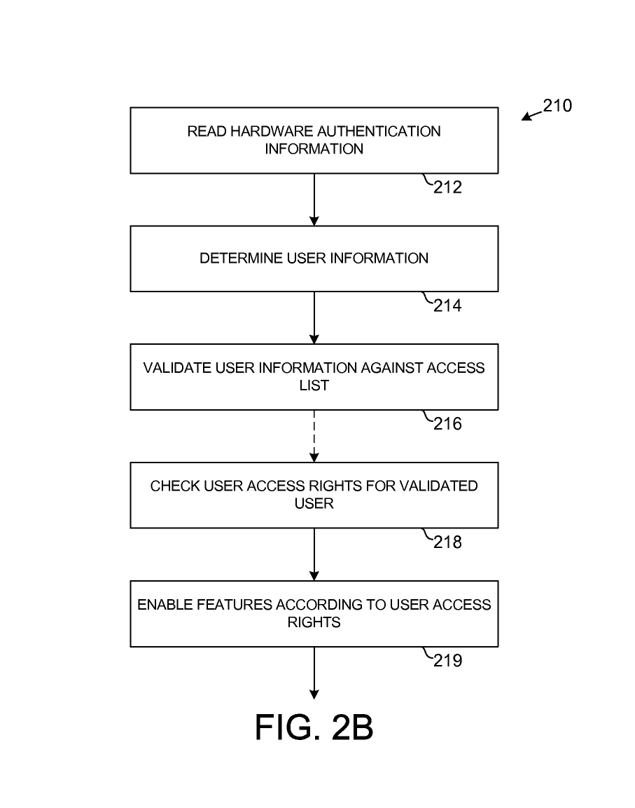

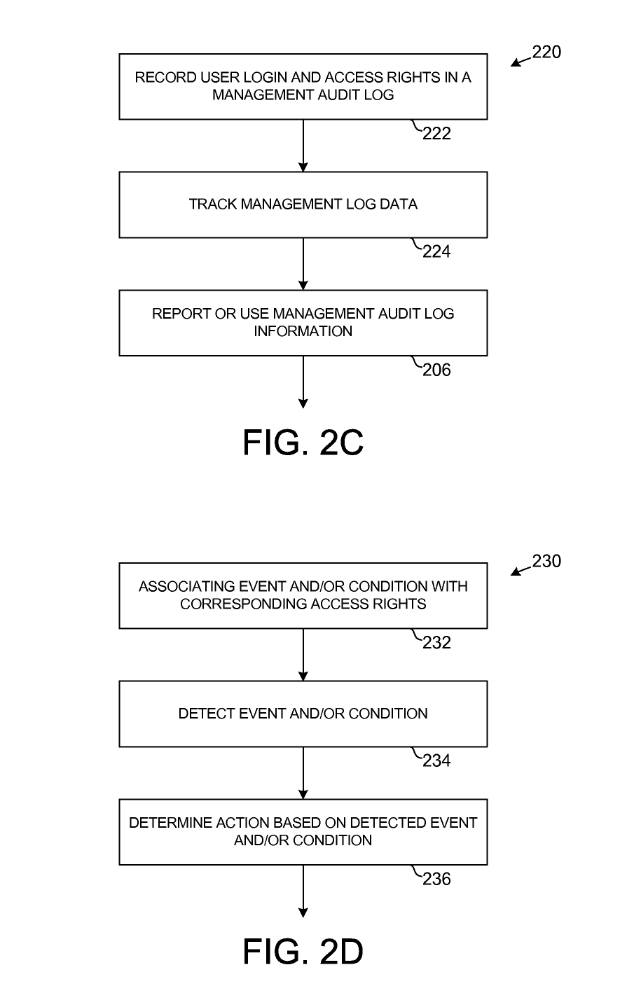

Referring to FIGS. 2A through 2D, multiple flow charts illustrate one or more embodiments or aspects of a method for securing access to an electronic system. FIG. 2A illustrates an embodiment of a method 200 for securing access to an electronic system that comprises allocating 202 access rights individually among multiple hardware and/or operation elements in the electronic system and individually securing 204 the hardware and/or operation elements with electronic and/or software-activated access. The selected units of the hardware and/or operation elements are authenticated 206 and operation is enabled 208 upon authentication.

In various applications or implementations, the hardware and/or operation elements can be secured 204 for example by securing removal of a hardware element with a lock, and/or by securing removal of a hardware element with a disable operation on the hardware and/or operation element if removed. Another technique secures removal and the operating environment of a hardware element with a two-part lock for the respective hardware element and the operating environment. Also, an operation can be secured by ensuring authentication for hardware element operation.

In some configurations, access permission can be associated in groups.

In some examples, theft can be deterred by enabling operation only by authentication.

For some applications, removal of a hardware and/or operation element can be disabled until access is authenticated. An example electronic system can have a default condition in which functionality of a hardware and/or operation element is disabled. Functionality of the hardware and/or operation element can be enabled by authentication. In other applications, functionality of a hardware and/or operation element can be disabled by removal of the element from an operating environment, rendering the element non-operational.

In a particular example, referring to FIG. 2B, secured access to the electronic system can be controlled 210 by operation of management software comprising reading 212 hardware authentication information, determining 214 user information, and validating 216 the user information against an internal and/or external access list that correlates the authentication information and the user information.

In some embodiments, secured access to the electronic system can further be controlled 210 by checking 218 user access rights for a validated user and enabling 219 features according to the user access rights.

Referring to FIG. 2C, a flow chart illustrates a further embodiment of a method 220 for secured access to an electronic system that comprises recording 222 user login and access rights in a management audit log and tracking 224 the management audit log using authentication information and events. The management audit log information can be reported 226 or used, for example to identify user access to resources.

Referring to FIG. 2D, a flow chart illustrates an embodiment of a method 230 for secured access to an electronic system comprising associating 232 an event and/or condition with corresponding access rights. Upon detecting 234 the event and/or condition, an action based on the detected event and/or condition and the associated access rights is determined 236.

In some implementations, access rights can be dynamically changed 238 based on the detected event and/or condition.

In another embodiment, secured access to the electronic system can be controlled for a shared hardware and/or operation element by defining multiple authorization domains for the shared element. Operation and/or access rights are enabled for the shared hardware and/or operation element upon successive authentications for each of the multiple authorization domains.

The described electronic system and associated techniques enable protection of individual physical hardware resources, and further enable administrators to grant physical access to resources on a need-to-have basis, thus greatly improving security.

Resource security is becoming increasingly important to government and business users. Much of the attention on security is focused on the network and application with physical access threats at the server level overlooked. The illustrative electronic system and associated methods enables security at the server level and even the lowest component levels, as well as at the network and application levels.

Using illustrative system and methods enable additional protection from current methods by allowing access to each server resource on a need-to-have basis. Complex security policies can be realized. Access can be granted per resource based on user ID and some expected maintenance time. For example, a specified user can be allowed to access the chassis for processor upgrades, but only on a particular date during a particular time window. The illustrative flexible technique can be tailored to particular security policies.

Using logical access authentication rather than lock and key can greatly simplify physical access management. Adding and removing users becomes trivial without changing physical locks. Users can easily be grouped into access groups which can be managed easily. Predefined group permissions simplify definition of user rights. Management of physical access rights can be centralized.

The illustrative security platform is easily extensible. Auditing facilitates tracking of login identity for physical access, as well as time and actions performed during the physical access, supplying information compilation and security reporting, for example for compliance with various regulatory bodies. New features can be easily developed to comply with future regulations.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, functionality, values, process variations, sizes, operating speeds, and the like. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. A method for securing access to an electronic system comprising:
allocating access rights individually among a plurality of hardware and/or operation elements in the electronic system;
individually securing the plurality of hardware and/or operation elements with electronic and/or software-activated access;
authenticating ones of the hardware and/or operation element plurality; and
enabling operation of ones of the hardware and/or operation element plurality upon authentication.

2. The method according to claim 1 wherein the electronic system is selected from among a group consisting of:
a server, a partitioned server, a bladed server, a server rack, a computer system, a consumer electronic system, a network system, a network switch, a storage array, a disk array, a smart-device disk array, a cellular telephone, a communication system, an entertainment system, and an electronic property.

3. The method according to claim 1 further comprising:
authenticating access to the hardware and/or operation element plurality by at least one security technology selected from a group consisting of retina scan biometric, fingerprint biometric, voice recognition, image recognition, smart card, personal radio frequency identification (RFID), a secure virtual electronic authentication, a keyboard and/or keypad entry with login password, a magnetic swipe card and pin, a servo-electronic-activated physical barrier protecting a resource, an encryption key that enables data usage, a two-part key associated with respective resource and chassis enabling operation only in combination, firmware enablement of a feature and/or an associated resource, enablement of an operating system and/or executable application, and a combination of security technologies.

4. The method according to claim 1 further comprising:
authenticating access to the hardware and/or operation element plurality by at least one security technology selected from a group consisting of an execution mode enabled by authorization as part of an authorization chain setting permissions for a plurality of security layers, and an execution mode selectively promoted or demoted by additional authorization.

5. The method according to claim 1 further comprising:
allocating access rights and securing the plurality of hardware and/or operation elements selected from a group consisting of servers, partitioned servers, virtualized systems, optical devices, bladed servers, wide area network (WAN) port connections, local area network (LAN) port connections, processors, central processing units (CPUs), storage devices, disk arrays, switches, embedded system devices, communication interfaces, user interfaces, blades, partitions, chasses, disks, reset buttons, consoles, keyboards, mice, trackballs, joysticks, network interface controllers, storage controllers, disk controllers, memory, input/output (I/O) cards, power supplies, fans, field replaceable units (FRUs), light-emitting diodes (LED) displays, liquid-crystal displays (LCDs), diagnostic panels, displays, electronic devices, home electronic devices, and automobiles.

6. The method according to claim 1 further comprising:
allocating access rights selected from at least one of a group consisting of granular access rights wherein individual resources have an associated access right; locally managed access rights; centrally managed access rights; globally managed access rights; dynamic access rights that change dynamically with partitioning and/or virtualization with ownership changes tracked; group access rights managed according to user, resource, machine, and/or location; access rights determined according to executing operating system; access rights determined by hardware and event occurrence whereby malfunctioning hardware is accessible; access rights determined by location; access rights allocated to hardware in groups; access rights allocated to multiple users; access rights paired according to user and resource; access rights paired according to user and location; access rights stored on a protected resource; access rights encoded/encrypted for tamper prevention; access rights allocated according to resource capability and/or functionality; access rights interoperable with operating system and executable application for enable and disable; access rights allocated according to date and time; access rights defining resource capabilities; access rights requiring authentication to enable firmware and/or software features; access rights allocated as physical access permissions for bootstrap loading while an operating system is executing; access rights protecting resource removal, access rights requiring authentication for bootstrap loading of an operating system; access rights that are tracked during resource operation; access rights requiring correct running mode for executing software; access rights protecting resource usage; access rights protecting resource operation; access rights limiting operation to a designated location; access rights limiting operation to a designated shipping address and RFID data center location key; access rights protecting LAN port connections in a server or switch; access rights determine by events and/or conditions; access rights activating a resource that is disable by default; access rights activated by shipping of resource to an address; access rights that can be queried by an operating system or executable application during a working session; and access rights that are promoted and/or demoted during a working session.

7. The method according to claim 1 wherein securing the plurality of hardware and/or operation elements with electronically-activated access comprises:
securing removal of a hardware element with a lock;
securing removal of a hardware element with a disable operation on the hardware and/or operation element if removed;
securing removal and the operating environment of a hardware element with a two-part lock for the respective hardware element and the operating environment; and
securing an operation by ensuring authentication for hardware element operation.

8. The method according to claim 1 further comprising:
controlling secured access to the electronic system by operation of management software comprising:
reading hardware authentication information;
determining user information; and
validating the user information against an internal and/or external access list that correlates the authentication information and the user information.

9. The method according to claim 8 further comprising:
controlling secured access to the electronic system by operation of management software further comprising:
checking user access rights for a validated user; and
enabling features according to the user access rights.

10. The method according to claim 1 further comprising:
recording user login and access rights in a management audit log;
tracking the management audit log using authentication information and events; and
reporting management audit log information.

11. The method according to claim 1 further comprising:
associating an event and/or condition with corresponding access rights;
detecting the event and/or condition; and
determining an action based on the detected event and/or condition and the associated access rights.

12. The method according to claim 11 further comprising:
dynamically changing the access rights based on the detected event and/or condition.

13. The method according to claim 1 further comprising:
associating access permission in groups.

14. The method according to claim 1 further comprising:
deterring theft by enabling operation only by authentication.

15. The method according to claim 1 further comprising:
disabling removal of a hardware and/or operation element until access is authenticated.

16. The method according to claim 1 further comprising:
disabling functionality of a hardware and/or operation element by default; and
enabling functionality of the hardware and/or operation element by authentication.

17. The method according to claim 1 further comprising:
disabling functionality of a hardware and/or operation element by removal of the hardware and/or operation element from an operating environment whereby the hardware and/or operation element becomes non-operational.

18. The method according to claim 1 further comprising:
controlling secured access to the electronic system further comprising:
for a shared hardware and/or operation element, defining a plurality of authorization domains for the hardware and/or operation element; and
enabling operation and/or access rights for the shared hardware and/or operation element upon successive authentications for each of the plurality of authorization domains.

19. A control logic operational for securing access to an electronic system comprising:
an initialization logic operative to allocate access rights individually among a plurality of hardware and/or operation elements in the electronic system and individually secure the plurality of hardware and/or operation elements with electronic and/or software-activated access; and
an operational logic operative in response to attempted access by a user to authenticate ones of the hardware and/or operation element plurality and enable operation of ones of the hardware and/or operation element plurality upon authentication.

20. The control logic according to claim 19 wherein the electronic system is selected from among a group consisting of:
a server, a partitioned server, a bladed server, a server rack, a computer system, a consumer electronic system, a network system, a network switch, a storage array, a disk array, a smart-device disk array, a cellular telephone, a communication system, an entertainment system, and an electronic property.

21. The control logic according to claim 19 further comprising:
the operational logic operative for authenticating access to the hardware and/or operation element plurality by at least one security technology selected from a group consisting of retina scan biometric, fingerprint biometric, voice recognition, image recognition, smart card, personal radio frequency identification (RFID), a secure virtual electronic authentication, a keyboard and/or keypad entry with login password, a magnetic swipe card and pin, a servo-electronic-activated physical barrier protecting a resource, an encryption key that enables data usage, a two-part key associated with respective resource and chassis enabling operation only in combination, firmware enablement of a feature and/or an associated resource, enablement of an operating system and/or executable application, a combination of security technologies, an execution mode enabled by authorization as part of an authorization chain setting permissions for a plurality of security layers, and an execution mode selectively promoted or demoted by additional authorization.

22. The control logic according to claim 19 further comprising:
the initialization logic operative to allocate access rights and secure the plurality of hardware and/or operation elements selected from a group consisting of servers, partitioned servers, virtualized systems, optical devices, bladed servers, wide area network (WAN) port connections, local area network (LAN) port connections, processors, central processing units (CPUs), storage devices, disk arrays, switches, embedded system devices, communication interfaces, user interfaces, blades, partitions, chasses, disks, reset buttons, consoles, keyboards, mice, trackballs, joysticks, network interface controllers, storage controllers, disk controllers, memory, input/output (I/O) cards, power supplies, fans, field replaceable units (FRUs), light-emitting diodes (LED) displays, liquid-crystal displays (LCDs), diagnostic panels, displays, electronic devices, home electronic devices, and automobiles.

23. An electronic system comprising:
a plurality of physically and/or communicatively coupled hardware and/or operation elements; and
a control logic operational for securing access to the electronic system comprising:
an initialization logic operative to allocate access rights individually among the plurality of hardware and/or operation elements and individually secure the plurality of hardware and/or operation elements with electronic and/or software-activated access; and
an operational logic operative in response to attempted access by a user to authenticate ones of the hardware and/or operation element plurality and enable operation of ones of the hardware and/or operation element plurality upon authentication.
